(19) United States
(12) Patent Application Publication
(10) Pub. No.: US 2022/0343281 A1
(43) Pub. Date: Oct. 27, 2022

(54) SYSTEM AND METHOD FOR PRODUCT DEVELOPMENT AND PROTOTYPING

(71) Applicant: INDIAN INSTITUTE OF SCIENCE (IISC), Bengaluru (IN)

(72) Inventors: Balan GURUMOORTHY, Bengaluru (IN); Moothedath Chandran KUMARI, Bengaluru (IN)

(73) Assignee: INDIAN INSTITUTE OF SCIENCE (IISC), Bengaluru (IN)

(21) Appl. No.: 17/761,587

(22) PCT Filed: Sep. 18, 2020
(86) PCT No.: PCT/IN2020/050801

§ 371 Date: Mar. 17, 2022

(30) Foreign Application Priority Data
Sep. 18, 2019 (IN) 201941037631

(51) Int. Cl. G06Q 10/10

(52) U.S. Cl. CPC G06Q 10/103; G06Q 10/101

(57) ABSTRACT

A system for product designing includes a storage unit and an interaction system communicably coupled with the storage unit. The interaction system includes at least one processor and a memory. The interaction system operates by provisioning an access to at least one user and receive a communication from the at least one user for designing a product. The interaction system receives a reply from the at least one user and facilitates interaction among the at least one user based on the reply received from the at least one user to create a group of users. The group of users are provided with at least one designing tool for designing the product. Also disclosed is the method of product designing.

### CROSS-REFERENCE TO RELATED APPLICATIONS

This application is a national phase application of and claims priority to patent application PCT/IN2020/050801 filed 18 Sep. 2020, and which was filed in English, is pending and is hereby incorporated by reference in its entirety for all purposes. Application PCT/IN2020/050801 is a PCT application of and claims priority to Indian application 201941037631 filed 18 Sep. 2019, and is hereby incorporated by reference in its entirety for all purposes.

### FIELD OF THE INVENTION:

The present invention relates to an interactive system that enables users from collocated or different geographical areas to interact and collaborate for a product development and/or prototyping.

### BACKGROUND OF THE INVENTION

A product development process is a multi-faceted and strenuous process involving interactions with different stakeholders at each stage. For a product to turn into a successful business in market, the process involves major stages such as identifying customer needs and opportunities, product designing, prototyping and testing and commercialization. Typical product development can take years for completion, depending on the complexity of the product.

Traditionally, such interactions require individuals to be physically present and conduct surveys through a face-to-face discussion with customers in order to identify a customer need or a product opportunity in the market. When any individual has to carry out such survey, they often lack sufficient resources to conduct the survey in the scale required by a business. The stage of product design is also challenging since for product designing there is need for interaction with different individuals including experts in varied domains. There is also a need for a team formation comprising of experts for the completion of product design process. Traditionally, such a team formation requires the individuals to be physically present at a common location in order to perform design activities together and review designs. After the completion of product designing, the next stage in product development is prototyping. Prototyping involves identifying suitable suppliers for components and fabrication facilities and getting quotes from them apart from inspecting a prototype made using the product design. Interaction and team formation is also required at the stage of prototyping to inspect and review the prototypes thus made. Once the product is designed and suitable product parts are obtained, the next step in product development is manufacturing and commercialization. For commercialization, there is a need to search for suitable incubation facilities and apply for the same. Hence, interaction and team formation is also required at the stage of commercialization.

Nowadays, several tools are available online, which enable the individuals to engage and interact even from remote locations. Few examples of such tools include email, social media, text messaging, image sharing tools, voice and video calling apps etc. However, such tools help in communicating and interacting with known individuals. Currently, there are also many online question and answer portals available, which enable users to post any queries to general public and get answers. However, in such portals, product design requirements or queries are posted on an ad-hoc basis to which the designers respond and engage with the work individually. For example, if a low-literate farmer in a remote location has a need for a new product to help him harvest crop faster, he/she may not be accessible for surveys on site nor be able to create an account in for example a question and answer (Q&A) portal and post request and identify a designer or a product. If an individual designer at a remote location wishes to design a product for agricultural domain and establish a business, the person may not have access to resources to travel and survey farmers.

Therefore, there is need for an interactive system that is flexible and user friendly to allow interaction at any stage of product development. The system should aid in connecting with individuals, customers, designers, organizations, mentors, fabricators, incubation facilities, innovation centres in universities and schools from different geographical areas.

### SUMMARY OF THE INVENTION

According to an embodiment, the present invention discloses a system for product designing. The system includes a storage unit and an interaction system communicably coupled with the storage unit. The interaction system includes at least one processor and a memory coupled to the at least one processor. The memory includes at least one instruction executable by the at least one processor. The processor is operable when executing the instructions to: provision an access to a at least one user; receive a communication from the at least one user for designing a product; receive a reply from the at least one user in response to the communication; facilitate interaction among the at least one user based on the reply received from the at least one user to create a group of users; and provision the group of users with at least one designing tool for designing the product.

According to an embodiment, the present invention discloses a method for product designing. The method employs a system for product designing. The system for product designing includes of a storage unit; an interaction system communicably coupled with the storage unit, the interaction system comprising of: at least one processor, and a memory coupled to the at least one processor. The method includes the steps of provisioning by the at least one processor, an access to at least one user; receiving, by the at least one processor, a communication from the at least one user for designing a product; receiving, by the at least one processor, a reply from the at least one user in response to the communication; facilitating, by the at least one processor, an interaction among the at least one user based on the reply received from the at least one user to create a group of users; provisioning, by the at least one processor, with at least one designing tool for designing the product to the group of users.

### BRIEF DESCRIPTION OF THE DRAWINGS

The foregoing and other features of embodiments of the present invention will become more apparent from the following detailed description of embodiments when read in conjunction with the accompanying drawings. In the drawings, like reference numerals refer to like elements.

FIG. 1 illustrates an exemplary network environment for implementing a system and method for product designing, in accordance with an embodiment of the present invention.

FIG. 2 illustrates an exemplary interaction system for implementing a system for product designing, in accordance to an embodiment of the invention.

FIG. 3 illustrates an exemplary design contest module for implementing a system for product designing, in accordance to an embodiment of the invention.

FIG. 4 illustrates an exemplary knowledge management module for implementing a system for product designing, in accordance to an embodiment of the invention.

FIG. 5 provides for a flow diagram of an exemplary method for product designing, in accordance with an embodiment of the present invention.

### DETAILED DESCRIPTION

In the following detailed description, reference is made to the accompanying drawings that form a part hereof, and in which shown by way of illustration specific embodiments that may be practiced. These embodiments are described in sufficient detail to enable a person skilled in the art to practice the invention, and it is to be understood that other embodiments may be utilized and that logical, mechanical, and other changes may be made within the scope of the embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. The singular forms “a,” “an,” and “the” include plural references unless the context clearly dictates otherwise. The following detailed description is, therefore, not be taken as limiting the scope of the invention, but instead the invention is to be defined by the appended claims.

According to an embodiment, the present invention discloses a system for product designing. The system includes a storage unit and an interaction system communicably coupled with the storage unit. The interaction system includes at least one processor and a memory coupled to the at least one processor. The memory includes at least one instruction executable by the at least one processor. The processor is operable when executing the instructions to: provision an access to a at least one user; receive a communication from the at least one user for designing a product; receive a reply from the at least one user in response to the communication; facilitate interaction among the at least one user based on the reply received from the at least one user to create a group of users; and provision the group of users with at least one designing tool for designing the product.

FIG. 1 illustrates an exemplary network environment 100 for implementing the system for product designing, in accordance with an embodiment of the present invention. The environment 100 depicts the system for product designing 102 including a storage unit 104 and an interaction system 106. The storage unit 104 and the interaction system 106 are communicably coupled with each other. In an embodiment of the present invention, the storage unit 104 and the interaction system 106 may be communicably coupled using wired means, wireless means, or a combination thereof. In an embodiment of the present invention, the interaction system 106 may be configured as web-based application. In another embodiment of the present invention, the interaction system 106 may be configured as mobile device application.

The interaction system includes at least one processor 108 and a memory 110. In an embodiment of the present invention, the interactive system may include more than one processor. In an embodiment of the present invention, the memory 110 is capable of storing at least one instruction. In an embodiment of the present invention, the at least processor 108 is capable of executing at least one instruction.

In an embodiment of the present invention, the at least processor 108 may be part of a server, a client network, a network infrastructure, a mobile computing platform, a stationary computing platform, and the like. In an embodiment of the present invention, the at least one processor 108 may be any kind of a computational device or a processing device capable of executing a program at least one instruction, at least one code, at least one binary instruction and the like. In an embodiment of the present invention, the at least one processor 108 may be a signal processor, a digital processor, an embedded processor, a microprocessor or any such variant. Non-limiting examples of the at least one processor 108 include a co-processor such as a math co-processor, a graphic co-processor, a communication co-processor and the like, that may directly or indirectly facilitate execution of the at least one instruction stored in the memory. In another embodiment of the present invention, the at least one processor 108 may enable execution of multiple programs, threads, and codes. In an embodiment of the present invention, the at least one instruction may be executed simultaneously to facilitate simultaneous operations of the application. In another embodiment of the present invention, the at least one instruction may be executed in a sequential manner. In an embodiment of the present invention, the at least one processor 108 may include one or more cores that may enhance speed and performance of a multiprocessor. In another embodiment of the present invention, the at least one processor 108 may be a dual core processor, a quad core processor, or a chip-level multiprocessor and or a processor that can combine two or more independent cores

In an embodiment of the present invention, the interactive system 104 also includes an input/output device 112. The input/out device 112 may include but is not limited to a display, a touchscreen, a mouse, a touchscreen pen, a keyboard, a microphone, soft keys and associated controllers for the input/output devices.

In an embodiment of the present invention, the at least one processor 108 of the interactive system 106 is configured to provision an access to the at least one user. In an embodiment of the present invention, the at least one user may access the interaction system using an electronic device For example, referring to FIG. 1, the at least one user 114a, 114b 114c . . . 114n, may access the interactive system 106 using an electronic device respectively. Examples of the electronic devices may include, but are not limited to a computer, a laptop, a mobile phone, a smartphone, a tablet device, a notebook, a wearable device, and the like. In an embodiment of the present invention, the interaction system may be accessed through a network 116. In another embodiment of the present invention, network 116 may include, but are not limited to a wired network, a wireless network, or a combination thereof. Examples of wired network may include Ethernet, local area network (LAN), fiber-optic cable network and the like. Examples of wireless network may include cellular network like GSM (global system for mobile communication), 3G (third-generation), 4G (fourth-generation), 5G (fifth-generation) CDMA (code division multiple access) based network, wireless LAN, Bluetooth® network, Zigbee® network, and the like. An example of a combination of wired and wireless network may include the Internet.

In an embodiment of the present invention, the at least one user may access the interaction system 106 by creating an account and becoming a registered user. In an embodiment of the present invention, the creation of account may involve providing a user profile information. Examples of the user profile information may include, but are not limited to, name of user, location of the user, name of the organization or university, job title and area of interest or speciality and the like. In an embodiment of the present invention, the at least user may choose to retain certain information as private and preclude their display on the user profile when viewed by another of the registered user.

In another embodiment of the present invention, the at least one user may access the interaction system 106 as a non-registered user. In an embodiment of the present invention, the registered and the non-registered user may access the interaction system providing unique user identification information. Examples of unique user identification information may include, but are not limited to, username, password, mobile number, one-time password and the like.

In one embodiment of the present invention the at least one user may include, but is not limited to, an organization, an university, a technologist or a researcher, an engineer, a designer, subject matter expert, student, design student, educators and the like. In another embodiment of the present invention, the at least one user may include, a farmer, a vegetable seller and the like. In yet another embodiment of the present invention, the at least one user could be a designer, a subject matter expert, or an individual who may have skills and technical knowledge to participate in a discussion or may be capable of aiding in product designing.

In an embodiment of the present invention, the at least one processor 108 of the interactive system 106 is configured to receive communication from the at least one user for the product designing. In one embodiment of the present invention, the communication from the registered user may include a subject matter for a discussion, a need for a product to be developed or designed, details of a project to be completed, a solution to be marketed and the like. In another embodiment of the present invention, the communication from the at least one user may be received in a written form. In another embodiment of the present invention, the communication from the at least one user may be received in the form of, but not limited to, an image, an audio or a video recording, a two-dimensional or a three dimensional drawing or a combination thereof. In another embodiment of the present invention, the communication from the at least one user is received through an augmented reality/a virtual reality/a mixed reality (AR/VR/MR) system.

In an embodiment of the present invention, the product designing may include, but is not limited to, product development, prototyping, redesigning of existing products and the like.

In an embodiment of the present invention, the at least one processor 108 of the interactive system 106 is configured to receive a reply from the at least one user in response to the communication. In an embodiment of the present invention, the reply from the at least one user may include, but is not limited to, suggestions, willingness to design, or enquiring more details on the need, providing details where to buy a solution and the like. In an embodiment of the present invention, the reply from the at least one user may be in the form of but not limited to, a text, an image, an audio, video recording, a drawing, a computer-aided design file bookmarking, and the like.

In an embodiment of the present invention, the communication from the at least one user and the reply received from the at least one user is in real-time.

In one embodiment of the present invention, the communication from the at least user can be posted in a native language from a mobile device. Native language can be defined as the language spoken or understood by the at least one user. In another embodiment of the present invention, the communication posted may be automatically translated from native language to a user specific language. In yet another embodiment of the present invention, communication from the at least user may be posted in an audio format or a video format which can be converted into text format. In another embodiment of the present invention, communication from the at least one user may be posted in an audio format or a video format which can be converted into text format automatically or manually. In an embodiment of the present invention, the communication from the at least one user that is converted into text can be automatically tagged with keywords. In an embodiment of the present invention, the reply received from the at least one user may be automatically translated from the user specific language to native language. In an embodiment of the present invention, the reply received from the at least one user may be manually translated from the user specific language to native language. In an embodiment of the present invention, the reply from the at least one user received in a text format can be automatically converted into an audio format and/or a video format.

In an embodiment of the present invention, the at least one processor 108 of the interactive system 106 is configured to facilitate interaction among the at least one user based on the reply received from the at least one user to create a group of users. In an embodiment of the present invention, interaction may include collaboration. In an embodiment of the present invention, the group of users may be created by inviting the at least one user. In an embodiment of the invention, the invitation to the at least one user may be sent through an email ID. In an embodiment of the present invention, the user may accept the invitation. In another embodiment of the invention, the at least one user may reject the invitation. In an embodiment of the present invention, the group of user may be a private group. In another embodiment of the present invention, the group of users may be a public group. For example, the group of users of the public group will always be visible to the at least one user irrespective of whether the user is part of the private group or a public group.

In another embodiment of the present invention, the group of users may be created automatically based on varied parameters for example based on a geographical location of the at least one user. In another embodiment of the present invention, the group of users may restrict a sub set of users selected from the at least one user from interacting in the group of users. In an embodiment of the present invention, more than one group of users may be created simultaneously.

In an embodiment of the present invention, the group of users may be tagged to a project name. In one embodiment of the present invention, the project name may include project information. In an embodiment of the present invention, project information may include, but not limited to, details of the product to be designed, timelines for completion of product designing, information of the at least one user within the group of users, keywords linked to the product to be designed, status of product designing and the like. In an embodiment of the present invention, project name of a public group may be displayed to the at least one user searching for new projects to participate in. In another embodiment of the present invention, project information may be displayed to the at least one user searching for new projects to participate in.

In an embodiment of the present invention, the at least one user from the group of users may perform an activity. In an embodiment of the present invention, the activity may include marking status, uploading files, posting issues, creating project information, editing project information, deleting project information, assigning a task, resolving a task, reviewing a completed task, approving the completed task, rejecting a task, resubmitting a task and the like. In an embodiment of the present invention, the project information and status of activity is updated automatically.

In an embodiment of the present invention, the at least one user from the group of users may be identified as the project leader of the group of user. In an embodiment, the project leader may choose the at least one user from the group of users as additional project leader for the group of users.

In an embodiment of the present invention, the at least one processor 108 of the interactive system 106 is configured to provision the group of users with at least one designing tool for the product designing. In another embodiment of the present invention, the at least one designing tool aids the at least one user from either a collocated geographical area or different geographical area to interact with each other. Example of the at least one designing tool includes, but not limited to, a text chat module, a video chat module, an audio format, a white board, an image annotation, a voice annotation, a tool to create, share, upload and discuss design related collaterals like sketches, images, drawings, a CAD model, two dimensional model, three dimensional models, an augmented reality/a virtual reality/a mixed reeality (AR/VR/MR) models etc. In an embodiment of the present invention, the at least one designing tool provides for an option to edit, delete, filter, annotate, comment, zoom, rotate, download, arrange or a combination thereof.

In an embodiment of the present invention, the group of users may interact synchronously for the product designing. Synchronous interaction as used herein allows multiple of the at least one users from the group of users to interact and collaborate at the same time.

In another embodiment of the present invention, the group of users may interact asynchronously for the product designing. Asynchronous interaction aids the at least one users from the group of users in managing project schedule, tasks, issues, files, using designing tools etc.

In an embodiment of the present invention, the interactive system also enables the at least one user from the group of users to add tools and features to the project that the at least one user from the group of user may use during the course of product designing.

In an embodiment of the present invention, the storage unit 104, depicted in FIG. 1 may be configured to store all information related to the group of users, such as for example user profile information, posts of the at least one user from the group of user, tags for each post, groups that the at least user is part of, text and video chats involving the at least one user, text and multimedia files associated with the at least one user, and the like.

In an embodiment of the present invention, the at least one user may access the system for product designing at any stage of product designing.

In an embodiment of the present invention, the product designing may be conducted offline after viewing the communication from the at least one user.

In an embodiment of the present invention, more than one group of the group of users may be formed for the same product designing.

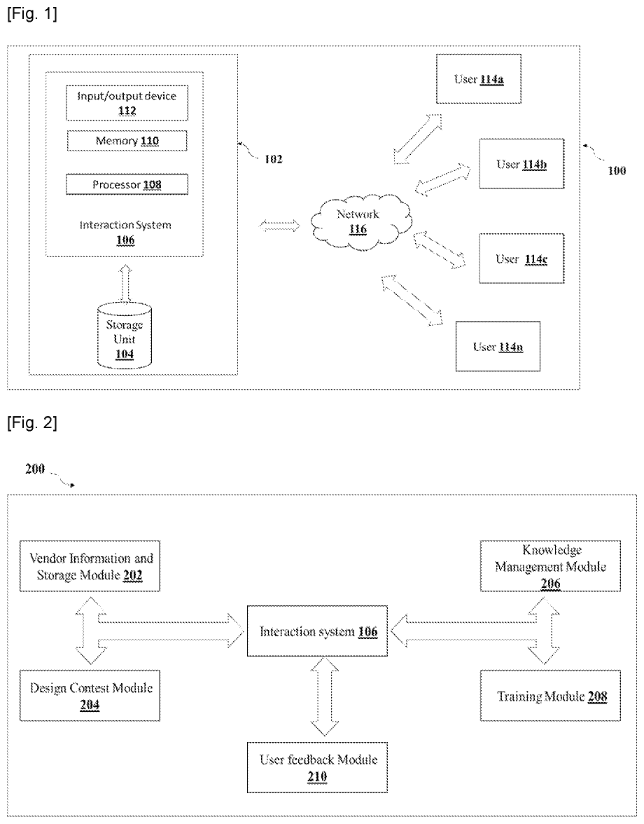

In an embodiment of the present invention, the system for product designing further comprises of a vendor information storage module comprising at least one vendor detail. FIG. 2 illustrates an exemplary interaction system for implementing the system for product designing, in accordance to an embodiment of the invention. In an embodiment of the present invention, the interaction system 106 further includes a vendor information and storage module 202, a design contest module 204, a knowledge management module 206 and a training module 208. In an embodiment of the present invention, the interaction system 106 may include either independently or in combination more than one of the vendor information and the storage module 202, the design contest module 204, the knowledge management module 206 and the training module 208.

In an embodiment of the present invention, the vendor may include but not limited to, manufacturers, fabricators, service providers, sponsors, private funding agencies, investors from government ministries, startup companies, incubators and the like. In an embodiment of the present invention, at least one vendor detail may include, but not limited to the vendor name, service provided by the vendor, facilities available with the vendor, rental rates, current status, contact number of the vendor, location of the vendor and the like. For example, a private incubator can sign up as vendor and provide details such as prototyping facilities available, desk rental rates, term dates, location map, number of start-ups graduated, current occupation status, number of open places.

In an embodiment of the present invention, the at least one user may communicate with the vendor from the vendor information storage module 202 and submit a request for support. In another embodiment of the present invention, the at least one user may search for any vendor based on the vendor detail. In an embodiment of the present invention, support may include but not limited to manufacturing consultation, business consultation, procurement of products, getting a quote and the like. For example, the at least one user can contact a manufacturer to get a quote for a product part. After getting the quote, the at least one user can confirm by making an online payment and place an order for the product part with the manufacturer. The manufacturer can thereafter ship the product part to the at least one user and provide an online tracking link for a delivery status.

In an embodiment of the present invention, the at least one user may communicate with the vendor and form a group. In an embodiment of the present invention, facilitating formation of the group of users with the at least one vendor, may be performed as explained with reference to the interactive system 106 (FIG. 1).

In an embodiment of the present invention, the system for product designing may automatically suggest a list of vendors based on the requirement of the at least one user. For example, the at least one user can identify a suitable incubation facility for booking based on an automatic recommendation given by the system. In one embodiment of the present invention the automatic recommendation is provided based on product details, profile of the at least one user, geographical location of the at least one user and the incubation facility, reviews provided by the at least one user regarding the incubation facility.

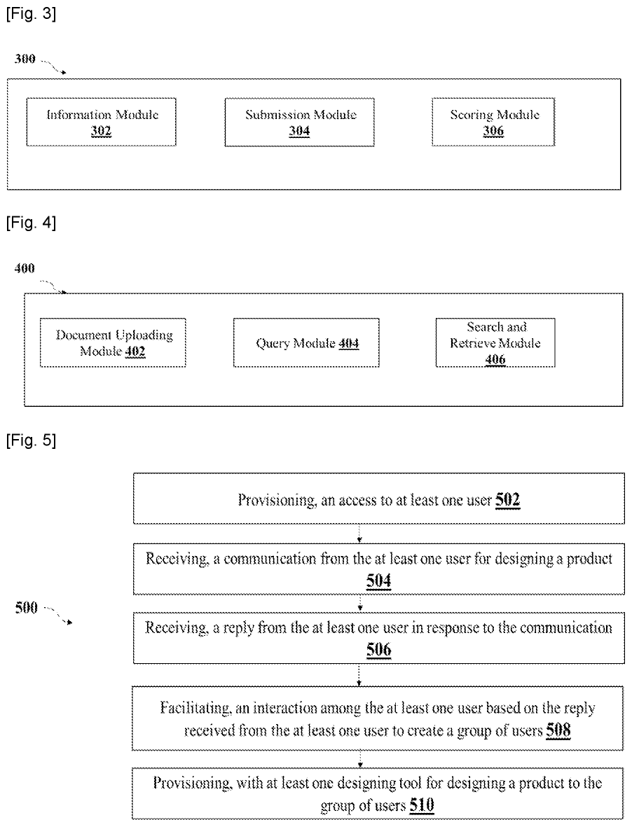

In an embodiment of the present invention, the system for product designing further includes of a design contest module 204, as depicted in FIG. 2. FIG. 3 illustrates an exemplary design contest module 300 for implementing the system and method for product designing. In an example embodiment of the present invention the design contest module 300 comprises of an information module 302, a submission module 304 and a scoring module 306. In an embodiment of the present invention, the design contest module 300 may include one or more modules either independently or in combination of the information module 302, the submission module 304 and the scoring module 306.

In an embodiment of the present invention, the information module 302 is configured to facilitate the at least one user to provide an information for the product designing. In an embodiment of the present invention, the information may include, but not limited to, a design problem providing the specification of the product to be designed, conditions of a design contest, material and geometrical constraints of the product to be designed, timeline of the design contest, team size for the design contest, judging criteria of the contest, prize money for the contest and the like. In an embodiment of the invention, the information may include supporting documents to aid the design problem. The supporting documents may include, but not limited to, an image, a video, an audio, a drawing, a Computer aided design (CAD) file and the like. In an embodiment of the present invention, the information may be edited and announced to the at least one user anytime during the course of the contest. In an embodiment of the present invention, at least one reminder may be posted during the course of the contest. In an embodiment of the present invention, the information of the design contest may be auto-tagged to a calendar under one or more than one category. Examples of categories may include, but not limited to, events by region, time, fee and the like. In an embodiment of the present invention, the at least one user may add the information of the design contest to a personal calendar of the at least one user. In one embodiment of the present invention, the calendar can provide the necessary reminder and alerts to the at least one user.

In an embodiment of the present invention, the submission module 304 is configured to receive a design submission developed in response to the information. In an embodiment of the invention, a group of users may interact to create a design submission. In another embodiment of the present invention, the group of users may use one or more of the features and tools provided in the interactive system to create a design submission. In yet another embodiment of the present invention, facilitating formation of group of users and provisioning the group of users with at least one designing tool for the product designing, may be performed as explained with reference to the interactive system 106 (FIG. 1).

In an embodiment of the present invention, the scoring module 306 is configured to score the design submission. In an embodiment of the present invention, the scoring the submissions is based on the degree to which the design submission meets the requirements outlined in the information. In an embodiment of the present invention, scoring the design submission is provided by a group of subject matter experts. In an embodiment of the present invention, a part of the scoring process may be conducted automatically. In an embodiment of the present invention, scoring the design submission aids to determine a winner for the design contest. In an embodiment of the present invention, the names of the winner of the design contest may be displayed to the at least one user. In an embodiment of the present invention, the winner of the design contest may be provided with an alert automatically.

In an embodiment of the present invention, the system for product designing further comprises of a knowledge management module 206, as depicted in FIG. 2.

FIG. 4 illustrates an exemplary knowledge management module 400 for implementing the system and method for product designing according to an embodiment of the invention. The knowledge management module 400 comprises of a document uploading module 402, a query module 404 and a search and retrieve module 406. In an embodiment of the present invention, the knowledge management module may include either independently or in combination one or more than one of the document uploading module 402, the query module 404 and the search and retrieve module 406.

In an embodiment of the present invention, the document uploading module 402 is configured to upload at least one document comprising at least one of a text data, an image data, a video data or an audio data. In an embodiment of the present invention, the document uploading module 402 is configured to upload at least one document in virtual reality or augmented reality or mixed reality model. Examples of the at least one document may include, but not limited to, a design knowledge document providing design methods and tools of designing, a design anthology document providing definition of various technical terms, article, presentations, papers, books, video lectures, geometric data, product model information, two-dimensional or three dimensional drawing, a computer aided design (CAD) file, a document providing information of design pedagogy, design curriculum, list of libraries and study spaces in various design schools and the like.

In an embodiment of the present invention, the document uploading module 402 identifies a set of rules associated with privacy and/or access rights of the at least one user. Examples of the set of rules include, but not limited to, rights to view a document, rights to publish a document, rights to edit and revise the document, adding a comment on the document, asking a question pertaining to the document and its contents, rights to review the document, sharing the document, collecting, bookmarking and the like.

In an embodiment of the present invention, the query module 404 is configured to receive a query from the at least one user. In an embodiment of the present invention, the query may be provided to the at least one user in the form recommendations.

In an embodiment of the present invention, the search and retrieve module 406 configured to search based on the query and retrieve the at least one document that is uploaded. In an embodiment of the present invention, the at least one document that is retrieved also provides for details of the at least one user who posted the document. In another embodiment of the present invention, the at least one document that is retrieved also provides for review and revision history.

In an embodiment of the present invention, the system further comprises of a training module 208, as depicted in FIG. 2, configured to conduct a training in a virtual space. In an embodiment of the present invention, training may include, but not limited to, tutoring the at least one user, conducting lab experiments, live lecturing, self-experimentation and the like. In an embodiment of the invention, training may include conducting an educational session between the at least one user i.e., may act like a session between a teacher and a student. In an embodiment of the present invention, training may include conducting a laboratory examination. In an embodiment of the present, a laboratory examination may be conducted along with experimentation. In an embodiment of the present invention, self-experimentation or conducting laboratory examination may involve reviewing the results and providing a score. For example, the teacher and the students can access the interactive system using a unique user identification information. Thereafter the teacher and student can conduct an interactive educational session or conduct a laboratory experimentation and examination.

In an embodiment of the present invention, virtual space includes a virtual reality space. In an embodiment of the present invention, virtual space includes a gamified environment. In another embodiment of the invention, virtual space includes an augmented reality space. In yet another embodiment of the present invention, virtual space includes a mixed reality space.

In an embodiment of the present invention, the training module 208 provides for a curriculum for the at least one user. In an embodiment of the present invention, curriculum may include, but not limited to, a course content, an experiment data, a presentation, a video or an audio describing the method to assemble and perform experiments and the like. In an embodiment of the present invention, the curriculum may be translated to any language of choice.

In an embodiment of the present invention, the training module 208 provides for features of commenting, posting a question, bookmarking, moderating and the like. In an embodiment of the present invention, the training module may provide a real-time assistance configured to navigate the at least on user in the virtual space.

In an embodiment of the present invention, the system further comprises of a user feedback module 210, as depicted in FIG. 2, configured to receive a feedback from the at least one user. Examples of feedback to include, but not limited to, reviews, comments, providing a ranking and the like. In an embodiment of the present invention, the at least one user may provide a feedback related to services or products provided by the vendor. In another embodiment of the present invention, the at least one user may provide a feedback related to the services provided by an expert or a sponsor.

In an embodiment of the present invention, the system further comprises of an artificial intelligence module (not shown in the figures) configured to assist the at least one user in an intelligent manner. As referred herein, an intelligent manner would refer to any one or more of the embodiments listed below. In an embodiment of the present invention, the artificial intelligence module shall provide list of possible designs based on a historical data. In another embodiment of the present invention, the artificial intelligence module may automatically identify at least one user who might have the necessary expertise for product designing in a related area or domain. In another embodiment of the present invention, the artificial intelligence module may automatically identify at least one designing tool required for product designing. In another embodiment of the present invention, the artificial intelligence module may automatically suggest the appropriate design method to the at least one user. In yet another embodiment of the present invention, the artificial intelligence unit may automatically suggest answers to similar questions.

In an embodiment of the present invention, the system provides for continuous monitoring and tracking of all the activities of the at least one user.

In an embodiment of the present invention, the system provides for continuous monitoring and tracking of all the activities in a project.

In an embodiment of the present invention, the system provides for automatic generation of a report on a status of the project reports.

In an embodiment, the present invention discloses a method for product designing. FIG. 5 provides for a flow diagram of an exemplary method 500 for product designing, in accordance with an embodiment of the present invention. The method 500 depicted in the flow diagram may be executed by, for example, the system 100 explained with reference to FIG. 1.

As shown in FIG. 5, the method includes a step 502 of provisioning an access to at least one user, by the at least one processor 108. At step 504, the method includes receiving a communication from the at least one user for designing a product, by the at least one processor 108. At step 506, the method includes receiving a reply from the at least one user in response to the communication 506, by the at least one processor 108. The method includes a step 508 of facilitating by the at least one processor 108, an interaction among the at least one user based on the reply received from the at least one user to create a group of users. The method includes provisioning 510 by the at least one processor 108, with at least one designing tool for designing a product to the group of users.

In an embodiment of the present invention, the method further comprises of facilitating communication between the at least one user and at least one vendor from the vendor information storage module. The method may be executed by, for example, vendor information and storage module 202 (FIG. 2).

In an embodiment of the present invention, the method further comprises a design contest via the design contest module 300. The method includes the steps of facilitating the at least one user to provide an information for the product designing via the information module 302. The method also includes the step of receiving a design submission developed in response to the information via the submission module 304 and scoring the design submission via the scoring module 306. The method may be executed by, for example, design contest module 300 (FIG. 3).

In an embodiment of the present invention, the method further comprises of provisioning a knowledge management via a knowledge management module 400. The method includes the steps of uploading at least one document comprising at least one of a text data, an image data, a video data or an audio data via the document uploading module 402. The method also includes the steps of receiving a query from at least one user via the query module 404. Thereafter searching in response to the query and retrieving the at least one document that is uploaded via the search and retrieve module 406. The method may be executed by, for example, knowledge management module 400 (FIG. 4).

In an embodiment of the present invention, the method further comprises of enabling the at least one user to conduct a training in a virtual space via a training module 208.

### EXAMPLE 1

The at least one use such as a farmer can access the system for product designing as a non-registered user. Access into the system can be obtained through a mobile application. After gaining access, a communication in the form of a video can be posted into the system. The video provides for a need to design a product, for example a tractor. The system converts the communication in the form of a video into text a format which can be viewed by the other users of the system. The system can also automatically convert a native language into say an english language. Thereafter, the at least one user, such as a subject matter expert, may reply to the post communicated by the farmer. The subject matter expert can interact with the at least one user of the system and form a group of users. The group of users may be a virtual team comprising of users from various geographical location. The group of users will be provided with at least one designing tool that will aid in designing the product. For example, the designing tool provides for synchronous interaction space and asynchronous interaction space. Synchronous interaction space comprises of real-time shared space and real-time non-shared space. The real-time shared space and real-time non-shared space provides for following features
1. Real-time shared space: The space provides for four menus—whiteboard, 3d model, image sharing and mindmap. All the users have synchronized access control to switch across menus. If one of the user from the group of users changes to mindmap menu, the change is visible to all the users within the group.
   (a) Whiteboard—The users can draw at same time and view the changes made in drawing with user name displayed along the mouse pointer location movements
   (b) Image Sharing—Any user can upload images and can also view the images uploaded by other users. Options are provided for editing the images, for annotating /posting comments. The user name will displayed to indicate the user who edited the image or posted the comment.
   (c) 3d modelling—The at least one user can upload neutral format CAD models and can also view the 3D models uploaded by other users. If one of the at least one users changes model it changes for all in the group of users. Options are provided for annotating specific points in the 3d space, viewing user annotations, editing, deleting. Options are also provided in real-time to zoom, rotate, download, delete.
   (d) Mind map—The at least one user can create a mind map with a name. New fields in the mind map can be added by the at least one user. If one of the at least one users changes mind map it changes for all in the group of users. Options are provided in real-time to edit/delete, download, pan and zoom mind map
2. Real time non-shared space: The group of users can view the project creator, percentage of completion, user status (joined, invited, created). The real-time non-shared space comprises of following menus
   (a) Message board: Instant messaging space on one side is visible simultaneously with shared space and video pane to the group of users. Options are provided to add attachments, preview of image attachment, post reply (text, audio post, attachment), view conversation thread, tag the name of the at least one user.
   (b) Video pane: Camera view pane of the group of users with live video call with audio. The group of users have the option to turn off/on the camera and audio. This pane also is visible simultaneously with shared space and message board

The asynchronous interaction space provides for following features:

1. Add/edit schedule with design stages timeline view and deadlines crossed in red.

2. Tasks and Issues page:
1. Add tasks under a project and assign to user. User assigned can change status to Complete, Ongoing and attach files to it. The at least one user can change status to Approve or Pending.
   a. Filter Issues by Tasks option
   b. Edit/delete option
2. Post design issues with image or any attachment with title and description, and tag to a task. Default status of the task will be Open. The at least one user can view it. Once the task is resolved, the status of the task is changed to closed.
   a. Filter Issues by Tasks option.
   b. Edit/delete option
3. Files: Uploading files by the at least one user under each task in files and automatic tagging of tasks completion.
   a. Files are automatically categorized based on completion status
   b. Files can be approved, rejected, by the at least one user
   c. Files can be displayed by most recently viewed, type of task tasks, approval status category for accessing latest updated files across by the at least one user.

The foregoing description of the preferred embodiment of the present invention has been presented for the purpose of illustration and description. It is not intended to be exhaustive or to limit the invention to the precise form disclosed. Furthermore, all examples recited herein are principally intended expressly to be only for pedagogical purposes to aid the reader in understanding the principles of the present subject matter and are to be construed as being without limitation to such specifically recited examples and conditions. Many modifications and variations are possible in light of the above teachings.

1. A system for product designing, the system comprising of:
a storage unit;
an interaction system communicably coupled with the storage unit;
the interaction system comprising
at least one processor, and
a memory coupled to the at least one processor 108, the memory comprising at least one instruction executable by the at least one processor, the at least one processor being operable when executing the instructions to:
provision an access to a at least one user;
receive a communication from the at least one user for designing a product;
receive a reply from the at least one user in response to the communication;
facilitate interaction among the at least one user based on the reply received from the at least one user to create a group of users;
provision the group of users with at least one designing tool for the product designing.

2. The system of claim 1, wherein the system further comprises a vendor information storage module comprising at least one vendor detail.

3. The system of claim 2, wherein the at least one user can communicate with the vendor from the vendor information storage module and submit a request for support.

4. The system of claim 1, wherein the system further comprises a design contest module 300 comprising
a information module to facilitate the at least one user to provide an information for the product designing;
a submission module to receive a design submission developed in response to the information; and
a scoring module to score the design submission.

5. The system of claim 1, wherein the system further comprises a knowledge management module comprising
a document uploading module configured to upload at least one document comprising at least one of a text data, an image data, a video data or an audio data;
a query module configured to receive a query from the at least one user;
a search and retrieve module configured to search based on the query and retrieve the at least one document that is uploaded.

6. The system of claim 1, wherein the system further comprises a training module configured to conduct a training in a virtual space.

7. A method for product designing employing a system for product designing comprising of a storage unit; an interaction system communicably coupled with the storage unit, the interaction system comprising of; at least one processor, and a memory coupled to the at least one processor, the method comprising:
provisioning by the at least one processor, an access to at least one user;
receiving by the at least one processor, a communication from the at least one user for designing a product;
receiving by the at least one processor, a reply from the at least one user in response to the communication;
facilitating by the at least one processor, an interaction among the at least one user based on the reply received from the at least one user to create a group of users;
provisioning by the at least one processor, with at least one designing tool for designing the product to the group of uers.

8. The method as of claim 7, wherein the method further comprises provisioning a design contest, comprising
facilitating the at least one user to provide an information for the product designing;
receiving a design submission developed in response to the information and
scoring the design submission

9. The method as of claim 7, wherein the method further comprises provisioning a knowledge management, comprising
uploading at least one document comprising at least one of a text data, an image data, a video data or an audio data;
receiving a query from at least one user;
searching in response to the query and retrieving the at least one document that is uploaded.

10. The method as of claim 7, wherein the method further comprises enabling the at least one user to conduct a training in a virtual space.
